(19) United States
(12) Patent Application Publication
(10) Pub. No.: US 2017/0049270 A1
(43) Pub. Date: Feb. 23, 2017

(54) FOOD IMPRINTING DEVICE

(71) Applicant: ON BREAD LTD., Jerusalem (IL)

(72) Inventor: Gilad COHEN, Lapid (IL)

(21) Appl. No.: 15/302,206

(22) PCT Filed: Jan. 1, 2015
(86) PCT No.: PCT/IL2015/050003

§ 371 Date: Oct. 6, 2016

(30) Foreign Application Priority Data
Apr. 10, 2014 (IL) 232080

(51) Int. Cl. A47J 37/08; A21C 15/00

(52) U.S. Cl. CPC A47J 37/0892; A21C 15/00; A23P 2020/253

(57) ABSTRACT

The present invention provides a food imprinting device, comprising at least one heat imprinting unit having a heatable printhead adapted to receive a supply of heat energy from a heating source, for searing the surface of a food product that comes in contact with said heatable printhead, by applying a necessary heat of at least 100 degrees Celsius and/or pressure of less than 25 seconds to said food product.

### FIELD OF THE INVENTION

The present invention relates to the field of impression devices. More particularly, the invention relates to an imprinting device designed to create images upon a variety of food products for decoration and/or marketing purposes, in particularly baked dough products such as flat bread or pitta.

### BACKGROUND OF THE INVENTION

It is sometimes desired by food products manufacturers to bring an added value and uniqueness to their product. This can be achieved by creating images (e.g., logo, letters, numbers, etc.) upon a variety of their food products for decoration and/or marketing purposes.

It is an object of the present invention to provide a device which is capable of industrially imprinting on a food product, in particular bread product.

It is another object of the present invention to provide a device for producing various selected designs on a food product such as a piece of bread.

Other objects and advantages of the invention will become apparent as the description proceeds.

### SUMMARY OF THE INVENTION

The present invention provides a food imprinting device, comprising at least one heat imprinting unit having a heatable printhead adapted to receive a supply of heat energy from a heating source, for searing the surface of a food product that comes in contact with said heatable printhead, by applying a necessary heat of at least 100 degrees Celsius and/or pressure of less than 25 seconds to said food product.

In one aspect, the food imprinting device further comprises at least one tray for supporting the food product. The heat imprinting unit can be mounted to a stand above, under or aside the tray.

According to an embodiment of the invention, at least one heat imprinting unit includes a manipulator on which the heatable printhead is mounted, wherein said manipulator being movable in one or more degrees of freedom for accurately positioning the printhead over a target food product. The manipulator is activated manually or automatically.

According to an embodiment of the invention, the heatable printhead is a plate having a relief that forms an image on the outer surface of said plate.

According to an embodiment of the invention, the heatable printhead is replacable or non replaceble.

According to an embodiment of the invention, the manipulator is controlled and activated by computerized module.

In one aspect, the at least one tray is disposed on a conveyor to be carried thereon.

According to an embodiment of the invention, the at least one tray having at least one cavity adapted for holding a food product therein.

According to an embodiment of the invention, the food imprinting device further comprises a controller for automatically controlling processing of the foodstuffs.

According to an embodiment of the invention, the tray is mounted on a base that defines a first arm and the heat imprinting unit is mounted on a frame that defines a second arm, such that both arms are joined by a hinge area which allows said arms to come together to close in order to apply the necessary heat and/or pressure to the food product. In one aspect, the second arm may include a chassis adapted to hold the printhead, and a stand for holding the heating source for heating said printhead by supplying heat energy.

According to an embodiment of the invention, the heating source is either attached to, or incorporated within, the heat imprinting unit.

According to an embodiment of the invention, the heating source is a burner.

According to an embodiment of the invention, the manipulator is controlled by an electro-mechanical unit for automatically applying the necessary heat and/or pressure to the food product.

According to an embodiment of the invention, the food imprinting device further comprises a handle to allow operating the device repeatedly. In one aspect, the handle is adapted to be operated manually. In another aspect, the handle is adapted to be operated electromechanically.

According to one embodiment of the invention, the food product is applied to the heatable printhead. According to other embodiments of the invention, the manipulator applies the heatable printhead to the food product.

### BRIEF DESCRIPTION OF THE DRAWINGS

In the drawings:

FIG. 1 schematically illustrates a heat pressing device for imprinting on a food product, according to an embodiment of the invention;

FIG. 2 schematically illustrates a bottom view of a metal template of attached to the device of FIG. 1, according to an embodiment of the invention;

FIG. 3 shows two rounded flat breads imprinted with the metal template of FIG. 2; and

FIG. 4 schematically illustrates a device for high-volume operations involving the continuous imprinting on food products, according to an embodiment of the present invention.

### DETAILED DESCRIPTION OF THE INVENTION

Reference will now be made to several embodiments of the present invention, examples of which are illustrated in the accompanying figures. Wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

The present invention is a heat pressing device that imprints (i.e., sears) a design or graphic on a variety of food products, such as a flat bread or pitta (i.e., a round Middle Eastern pocket bread), with the application of heat and pressure for a specific period of time (e.g., less than 25 seconds). Although the device is primarily intended for use in commercial and industrial locations, usage is not limited to such applications. The device may also be effectively used in residential settings as well as a variety of additional contexts.

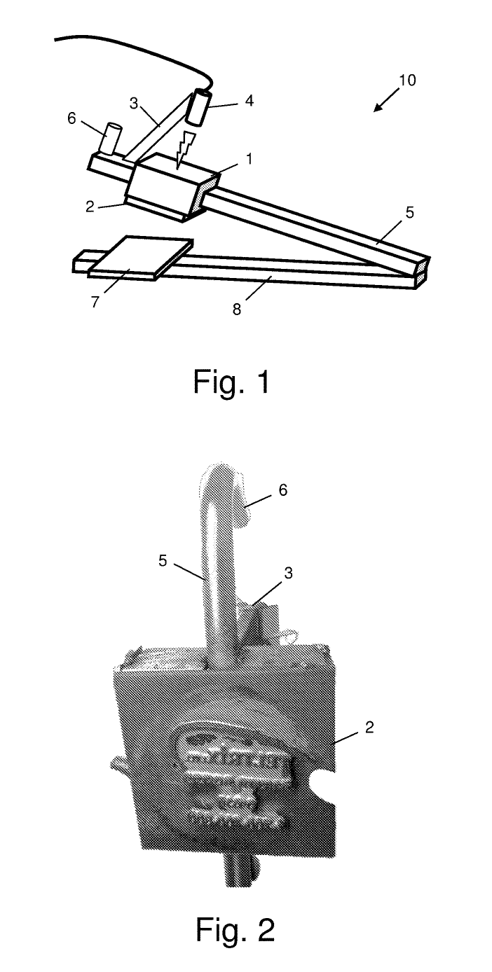

Specifically, as shown in FIG. 1, in an exemplary mode of production, a heat pressing food imprinting device 10 consists of two main assemblies an upper assembly and lower assembly. The upper assembly comprises an imprinting unit 1 adapted to hold a heatable plate 2 such as a metal template that is used as a “printhead” or a print applicator, and a heating source 4. In this exemplary configuration the imprinting unit 1 and the heating source 4 are mounted on an upper arm 5, wherein the heating source 4 is mounted to arm 5 via a supporting stand 3. In this embodiment, the arm 5 is provided with a handle 6 that is of sufficient size and configuration to allow a user to comfortably operate the device manually. According to another embodiment of the invention, the imprinting unit is adapted to be operated electromechanically (e.g., by an electro-mechanical unit) and/or by a computer system or a controller.

Importantly, the heating source 4 may be either attached to, or incorporated within, the assembly 5 depending upon manufacturer preference. In this exemplary configuration, the lower assembly comprises a tray 7 that is mounted to a lower arm 8.

In this exemplary embodiment, the heating source 4 is a mechanical device that burns a gas or liquid fuel into a flame in a controlled manner, such as a burner. Alternatively, the heating source 4 can be implemented by other heating generating techniques (e.g., electric heating) capable of heating the plate 2 such that it will be able to rapidly (e.g., a few seconds, preferably, less than 25 seconds) sear an image upon a food product while keeping the non-printing areas sear-free, and without damaging the original characteristics of the food product on its non-printing areas.

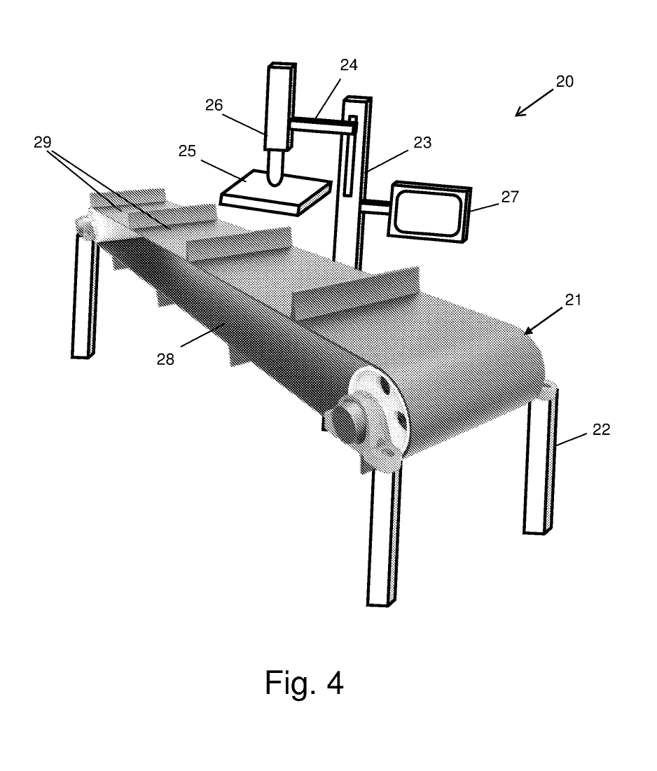

According one embodiment, imprinting unit 1 employs plate 2 to apply heat and pressure to the food product located on the tray 7 while keeping the non-printing areas sear-free and thereby undamaging the original food product characteristics. The heating source 4 (e.g., a burner) generates an energy (e.g., flame) that heats the plate 2 either directly or indirectly via a mediating element to which plate 2 is attached, such as a metal heat rod 9. For example, in this exemplary configuration, the upper assembly in the press opens like a clamshell structure that consist of two arms (e.g., upper arm 5 and lower arm 8) joined by a hinge area which allows the structure to come together to close. Alternatively, in a “swing-away” design, the upper assembly swings away from the tray 7 or vice-versa. Plate 2 can be made of any heatable material(s) that is resistive to high temperatures (e.g., above 100 Celsius degrees such as metal alloys that have copper as their principal component). Other arrangements can also be used to apply heat and/or pressure and/or contact to the food product, such as a millstones-like arrangement (not shown) that includes two wheels, where at least one wheel is moveable and the other wheel can be stationary. For example, one wheel can be used as the lower assembly of device 10 and the other wheel can be used as the upper assembly of device 10. In this example, the lower assembly can be stationary, and above the lower assembly is a turning upper assembly (i.e., the other wheel that may turn in any direction) that includes the imprinting unit which does the searing. The turning upper assembly spins above the stationary lower assembly creating the searing action on food product located between the upper and lower assemblies. An arrangement for applying high-volume operations that involves continuous imprinting will be described in further details hereinafter with respect to FIG. 4.

According to an embodiment of the invention, the imprinting unit 1 that holds the plate 2 is located on the distal end of the upper assembly 5, in such a manner that plate 2 faces down towards tray 7. Tray 7 is located on the distal end of the lower assembly 8, such that plate 2 will be able to apply heat and pressure to a food product that is placed on tray 7 upon pressing the upper assembly 5 towards the lower assembly 8. Plate 2 is replaceable (i.e., detachable from the imprinting unit 1) and may comprise any of a variety of patterns reliefs, to provide significant versatility for industrial, commercial, or residential usage.

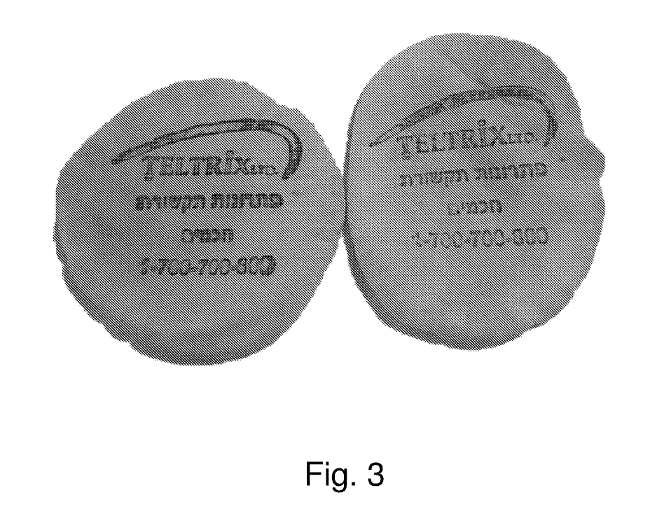

FIG. 2 shows a bottom view of plate 2 attached to the upper assembly. In this figure, plate 2 is provided with an exemplary relief of an image that can be used in conjunction with the invention. FIG. 3 shows two rounded flat breads imprinted with the image of plate 2 of FIG. 2.

As noted, plate 2 can be changed or replaced for printing different images. As such, different plates with variety of patterns may include snap-in arrangement (not shown), for allowing a simple replacement of one plate with another.

According to an embodiment of the invention, for high-volume operations involving the continuous imprinting of food products, automatic shuttle transfer presses or other conveyer arrangements can be used. The substrates to be imprinted are continuously loaded onto the tray 7 and shuttled under the imprinting unit 1, which then applies the necessary heat and/or pressure. The necessary heat and/or pressure can be applied automatically by an electro-mechanical control unit that is managed by a dedicated controller or computer system.

An example of an embodiment of a device for high-volume operations involving the continuous imprinting is shown in FIG. 4. In this embodiment, the device is embodied as a food imprinting workstation 20 that includes, a conveyor 21 which can be mounted on top of a base unit 22, a frame 23, an imprinting unit that include a manipulator 24 operatively mounted to frame 23 and a printhead 25 (e.g., a metal plate) connected to the manipulator 24, a heat source 26 for applying heat to the printhead 25 and a controller 27. Preferably, the imprinting workstation 20 is automated and computer-controlled for high-volume throughput processing of food products. The movements of the manipulator 24 which presses the printhead 25 on the food product can be actuated by any known means, such as linear actuators, pneumatic devices, push-pull systems, rack and pinion drives, and the like. According to some embodiments of the invention, the actuation of manipulator 24 is controlled by a computer system.

According to an embodiment of the invention, the gravitation can be used as the pressure source. In this embodiment, the food product can freely fall onto the heatable plate, such that the searing occurs without a direct pressure on the food product.

A foodstuff processing tray 28 having a plurality of compartments 29 is disposed on the conveyor 21 and holds a plurality of food products each in a separate compartment for pre-positioning the food products prior to imprinting the food product with printhead 25. The conveyor 21 is depicted as an endless belt that can be driven in one direction or in reversible directions for accurate pre-positioning. Tray 28 can be either a separate component freely supported on the conveyor 21 or an integrated component attached to or extending from the conveyor 21 in order to permit travel of the belt around the drive or driven rollers without interference. Tray 28 can be constructed from plastic, and each compartment 29 defines a suitable geometric shape (e.g., rectangular) for snugly holding individual food products therein. In some embodiments, the compartments 29 may also include a cavity shaped to correspond with the particular type of food product being printed upon (e.g., a rounded cavity for a round Pitta). Thus, the conveyor 21 can be filled with differently shaped food products in one or more of the compartments 29. Other materials, such as rubber, silicon, or combinations thereof can also be used to construct the tray 28. Harder materials, such as metal, and derivatives thereof, can also be used.

All of the above operations are preferably automated by the controller 27, which may be a microprocessor- or microcontroller-based device, such as a programmable logic controller, connected to appropriate sensors and servomechanisms. The controller 27 can also be programmed via a Human-Machine Interface (HMI), such as a touchscreen, to monitor the rate of processing, determine the information to be printed when using a dynamic plate, determine the type of food product being processed, set the necessary heat and/or pressure, the volume and weight of the food products being processed, etc. based upon user requirements and input.

Regarding the intended method of utilizing device 10, the user first has the imprinting unit 1 with proposed plate 2 installed. After the desired plate is installed, the heating source 4 is turned on and the plate 2 is pressed against the desired food product for searing. Such may be a single imprinting, or may alternatively be a series of separate movements to sear a repetitive pattern on the food products in question for high-volume operations that involves continuous imprinting.

Regarding manufacture of device 10, the modular components of the device may be injection molded, cast, molded, or machined from various materials. Such materials include, but are not limited to ferrous materials.

Importantly, regarding practicality of use of the device, it is also produced to withstand considerable heat. The heatable plate is also constructed to be highly durable in nature, particularly in light of its usage with direct heat source such as a flame that can reach above 100 Celsius degrees.

Moreover, the tray shapes of the device may vary significantly, to allow for additional versatility for the user. For the purposes of example only, such tray shapes may be anything from a rectangular (which may be used for flat bread) or circular (which may be used for a round shaped flat bread).

As will be appreciated by the skilled person the arrangement described in the figures results in a device for producing ornamental designs on a food product, in particular bread or flat bread and other baked dough products.

The terms, “for example”, “e.g.”, “optionally”, as used herein, are intended to be used to introduce non-limiting examples. While certain references are made to certain example system components, other components can be used as well and/or the example components can be combined into fewer components and/or divided into further components.

All the above description and examples have been given for the purpose of illustration and are not intended to limit the invention in any way. Many different mechanisms and heating elements can be employed, all without exceeding the scope of the invention.

1. A food imprinting device, comprising at least one heat imprinting unit having a heatable printhead adapted to receive a supply of heat energy from a heating source, for searing the surface of a food product that comes in contact with said heatable printhead, by applying a necessary heat of at least 100 degrees Celsius and/or pressure of less than 25 seconds to said food product.

2. A device according to claim 1, further comprising at least one tray for supporting the food product.

3. A device according to claim 1, in which at least one heat imprinting unit includes a manipulator on which the heatable printhead is mounted, wherein said manipulator being movable in one or more degrees of freedom for accurately positioning the printhead over a target food product.

4. A device according to claim 2, in which the heat imprinting unit is mounted to a stand above, under or aside the tray.

5. A device according to claim 1, in which the heatable printhead is a plate having a relief that forms an image on the outer surface of said plate.

6. A device according to claim 1, in which the heatable printhead is replacable or non replaceble.

7. A device according to claim 3, in which the manipulator is activated manually.

8. A device according to claim 3, in which the manipulator is activated automatically.

9. A device according to claim 3, in which the manipulator is controlled and activated by computerized module.

10. A device according to claim 2, in which the at least one tray is disposed on a conveyor to be carried thereon.

11. A device according to claim 2, in which the at least one tray having at least one cavity adapted for holding a food product therein.

12. A device according to claim 1, further comprising a controller for automatically controlling processing of the foodstuffs.

13. A device according to claim 2, in which the tray is mounted on a base that defines a first arm and the heat imprinting unit is mounted on a frame that defines a second arm, such that both arms are joined by a hinge area which allows said arms to come together to close in order to apply the necessary heat and/or pressure to the food product.

14. A device according to claim 13, in which the second arm includes a chassis adapted to hold the printhead, and a stand for holding the heating source for heating said printhead by supplying heat energy.

15. A device according to claim 1, in which the heating source is either attached to, or incorporated within, the heat imprinting unit.

16. A device according to claim 1, in which the heating source is a burner.

17. A device according to claim 2, in which the manipulator is controlled by an electro-mechanical unit for automatically applying the necessary heat and/or pressure to the food product.

18. A device according to claim 1, further comprises a handle to allow operating the device repeatedly.

19. A device according to claim 18, in which the handle is adapted to be operated manually.

20. A device according to claim 18, in which the handle is adapted to be operated electromechanically.

21. A device according to claim 1, in which the food product is applied to the heatable printhead.

22. A device according to claim 3, in which the manipulator applies the heatable printhead to the food product.
